(19) United States
(12) Patent Application Publication
(10) Pub. No.: US 2025/0158120 A1
(43) Pub. Date: May 15, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: JINAH SEO, Yongin-si (KR); Sujeong KOH, Yongin-si (KR); Erang Cho, Yongin-si (KR); Bomee KWON, Yongin-si (KR); JIN-HYEOK LIM, Yongin-si (KR); SANGHOON KIM, Yongin-si (KR); SUNDAE KIM, Yongin-si (KR); Euisoo JEONG, Yongin-si (KR)

(21) Appl. No.: 18/783,020

(22) Filed: Jul. 24, 2024

(30) Foreign Application Priority Data
Nov. 10, 2023 (KR) 10-2023-0155463

(51) Int. Cl. H01M 10/0567; H01M 4/02; H01M 4/525; H01M 4/583; H01M 10/0525; H01M 10/0568; H01M 10/0569

(52) U.S. Cl. CPC H01M 10/0567; H01M 4/525; H01M 4/583; H01M 10/0525; H01M 10/0568; H01M 10/0569; H01M 2004/027; H01M 2004/028; H01M 2220/10; H01M 2300/004

(57) ABSTRACT

Disclosed are an electrolyte and rechargeable lithium battery including the same. The electrolyte includes a non-aqueous organic solvent, a lithium salt, and an additive. The additive includes Compound 1 represented by Chemical Formula 1 and Compound 2 represented by Chemical Formula 2.

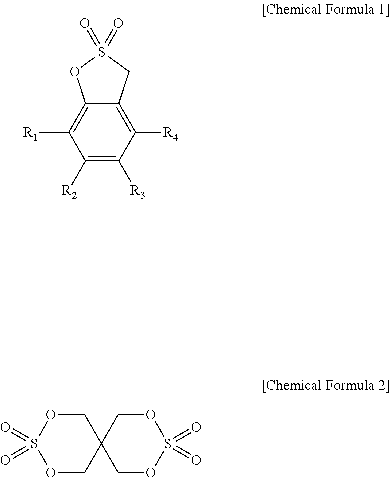

### CROSS-REFERENCE TO RELATED APPLICATION

The present application claims priority to and the benefit of Korean Patent Application No. 10-2023-0155463, filed on Nov. 10, 2023, in the Korean Intellectual Property Office, the entire content of which is hereby incorporated by reference.

### BACKGROUND

### 1. Field

Embodiments of the present disclosure relate to an electrolyte for a rechargeable lithium battery and a rechargeable lithium battery including the same.

### 2. Description of the Related Art

Recently, with the rapid spread of battery using electronic devices, such as mobile phones, laptop computers, and electric vehicles, there is a rapidly increasing interest in rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation are possible, and generates electrical energy caused by oxidation and reduction reactions if lithium ions are intercalated and deintercalated.

A lithium salt dissolved in a non-aqueous organic solvent may be used as the electrolyte of the rechargeable lithium battery. Characteristics of the rechargeable lithium battery are exhibited by complex reactions between the positive electrode and the electrolyte and between the negative electrode and the electrolyte. Accordingly, the use of a suitable or appropriate electrolyte is a variable for improvement of the rechargeable lithium battery.

### SUMMARY

An embodiment of the present disclosure provides an electrolyte for a rechargeable lithium battery having improved stability and lifetime characteristics at high temperatures.

An embodiment of the present disclosure provides a rechargeable lithium battery including the electrolyte.

According to an embodiment of the present disclosure, an electrolyte for a rechargeable lithium battery may include: a non-aqueous organic solvent; a lithium salt; and an additive. The additive may include Compound 1 represented by Chemical Formula 1 and Compound 2 represented by Chemical Formula 2.

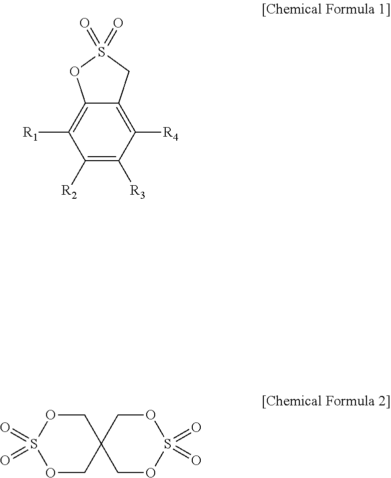

In Chemical Formula 1, R₁ to R₄ may independently be one selected from a hydrogen element, a halogen element, and a substituted or unsubstituted C1 to C5 alkyl group.

According to an embodiment of the present disclosure, a rechargeable lithium battery may comprise: a positive electrode that includes a positive electrode active material; a negative electrode that includes a negative electrode active material; and the electrolyte discussed above.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram showing a rechargeable lithium battery according to an embodiment of the present disclosure.

FIG. 2 is a simplified cutaway perspective view of a rechargeable lithium battery according to an embodiment of the present disclosure.

FIG. 3 is a simplified cross-sectional view showing a rechargeable lithium battery according to an embodiment of the present disclosure.

FIGS. 4-5 are simplified perspective views showing rechargeable lithium batteries according to embodiments of the present disclosure.

### DETAILED DESCRIPTION

In order to sufficiently understand the configuration and effect of the subject matter of the present, some embodiments of the present disclosure will be described with reference to the accompanying drawings. It should be noted, however, that the present disclosure is not limited to the following example embodiments, and may be implemented in various suitable forms. Rather, the example embodiments are provided only to illustrate embodiments the present disclosure and let those skilled in the art fully know the scope of the present disclosure.

In this description, it will be understood that, if an element is referred to as being on another element, the element can be directly on the other element or intervening elements may be present between therebetween. In the drawings, thicknesses of some components may be exaggerated for effectively explaining the technical contents. Like reference numerals refer to like elements throughout the specification.

Unless otherwise specially noted in this description, the expression of singular form may include the expression of plural form. In embodiments, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, and/or a reaction product.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may indicate that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may indicate that at least one hydrogen of a substituent or a compound is substituted by deuterium, a halogen group, a C1 to C20 alkyl group, a C6 to C30 aryl group, a C1 to C10 fluoroalkyl group, or a cyano group. In embodiments, the term “substituted” may indicate that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may indicate that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

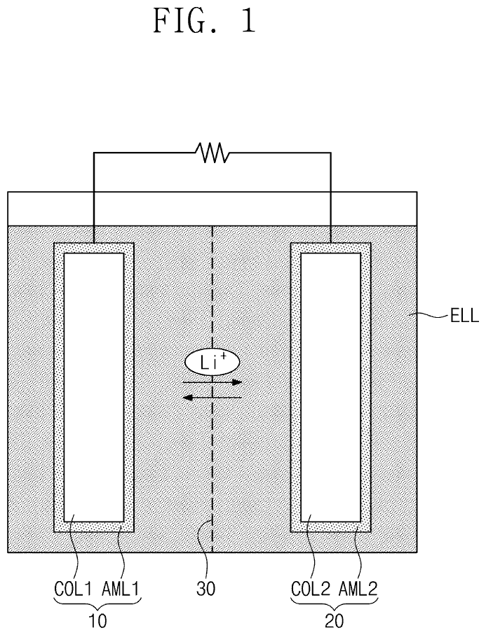

FIG. 1 illustrates a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one selected from the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may range from about 90 wt % to about 99.5 wt % based on 100 wt % of the positive electrode active material layer AML1. Amounts of the binder and the conductive material may be about 0.5 wt % to about 5 wt % based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode having conductivity (e.g., electrical conductivity), and any suitable conductive material without causing chemical change of a battery (e.g., that does not cause an undesirable chemical change to the rechargeable lithium battery) may be used as the conductive material to constitute the battery. The conductive material may include, for example, a carbon-based material such as natural graphite, artificial graphite, carbon black, acetylene black, Ketjenblack, carbon fiber, carbon nano-fiber, and/or carbon nano-tube; a metal powder and/or metal fiber containing one or more selected from copper, nickel, aluminum, and silver; a conductive polymer (e.g., an electrically conductive polymer) such as a polyphenylene derivative; or a mixture thereof.

Al may be used as the current collector COL1, but the present disclosure is not limited thereto.

### Positive Electrode Active Material

The positive electrode active material in the positive electrode active material layer AML1 may include a compound (e.g., a lithiated intercalation compound) that can reversibly intercalate and de-intercalate lithium. For example, the positive electrode active material may include at least one kind of composite oxide including lithium and metal that is selected from cobalt, manganese, nickel, and a combination thereof.

The composite oxide may include a lithium transition metal composite oxide, for example, a lithium-nickel-based oxide, a lithium-cobalt-based oxide, a lithium-manganese-based oxide, lithium-iron-phosphate-based compounds, a cobalt-free nickel-manganese-based oxide, or a combination thereof.

For example, the positive electrode active material may include a compound represented by one of chemical formulae below. LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GₑO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae above, A is Ni, Co, Mn, or a combination thereof, X is Al, Ni, Co, Mn, Cr, Fe, Mg, Sr, V, a rare element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high nickel-based positive electrode active material having a nickel content of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material in an amount of about 90 wt % to about 99 wt %, a binder in an amount of about 0.5 wt % to about 5 wt %, and a conductive material (e.g., an electrically conductive material) in an amount of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If an aqueous binder is used as the negative electrode binder, a cellulose-based compound capable of providing or increasing viscosity may further be included. The cellulose-based compound may include one or more selected from carboxymethyl cellulose, hydroxypropylmethyl cellulose, methyl cellulose, and alkali metal salts thereof. The alkaline metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable conductive material without causing chemical change of a battery (e.g., that does not cause an undesirable chemical change to the rechargeable lithium battery) may be used as the conductive material to constitute the battery. For example, the conductive material may include a carbon-based material such as natural graphite, artificial graphite, carbon black, acetylene black, Ketjenblack, carbon fiber, carbon nano-fiber, and/or carbon nano-tube; a metal powder and/or metal fiber including one or more selected from copper, nickel, aluminum, and silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal (e.g., an electrically conductive metal), or a combination thereof.

### Negative Electrode Active Material

The negative electrode active material in the negative electrode active material layer AML2 may include a material that can reversibly intercalate and de-intercalate lithium ions, lithium metal, a lithium metal alloy, a material that can dope and de-dope lithium, and/or a transition metal oxide.

The material that can reversibly intercalate and de-intercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOx (0<x<2), Si-Q alloy (where Q is alkali metal, alkaline earth metal, Group 13 element, Group 14 element (except for Si), Group 15 element, Group 16 element, transition metal, rare-earth element, or a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) on a surface of the secondary particle. The amorphous carbon may also be between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

### Separator 30

Based on type (or kind) of the rechargeable lithium battery, the separator 30 may be between positive electrode 10 and the negative electrode 20. The separator 30 may include one or more selected from polyethylene, polypropylene, and polyvinylidene fluoride, and may include a multi-layered separator thereof such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on one or opposite surfaces of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed together in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium that transmits ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1.4-dioxolane; and/or sulfolanes.

The non-aqueous organic solvent may be used alone or in a mixture of two or more substances.

In embodiments, if a carbonate-based solvent is used, a cyclic carbonate and a chain carbonate may be mixed together and used, and the cyclic carbonate and the chain carbonate may be mixed together in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFOB), and lithium bis(oxalato) borate (LiBOB)

The lithium salt may include LiPF₆.

The lithium salt may have a concentration of about 0.1 M to about 2.0 M.

The additive may include a vinylene carbonate-based compound. The vinylene carbonate-based compound may be added to an electrolyte to form a solid electrolyte interface (SEI) layer. The vinylene carbonate-based compound may be vinylene carbonate, vinylene ethylene carbonate, or a combination thereof.

The vinylene carbonate-based compound may be present in an amount of about 0.01 wt % to about 5 wt % relative to the total weight of the electrolyte. For example, the vinylene carbonate-based compound may be present in an amount of equal to or greater than about 0.05 wt %, about 0.1 wt %, or about 0.5 wt % relative to the total weight of the electrolyte. The vinylene carbonate-based compound may be present in an amount of equal to or less than about 3 wt %, about 2 wt %, or about 1.5 wt % relative to the total weight of the electrolyte. If the vinylene carbonate-based compound has the aforementioned concentration in the electrolyte, a solid electrolyte interface (SEI) layer having a suitable or appropriate resistance (e.g., electrical resistance) may be formed on an electrode surface to improve cycle characteristics of a lithium battery.

The additive may include Compound 1 represented by Chemical Formula 1 below.

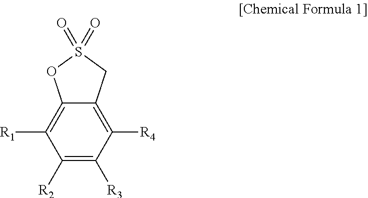

In Chemical Formula 1, R₁ to R₄ may independently be a hydrogen element, a halogen element, or a substituted or unsubstituted C1 to C5 alkyl group. In embodiments of Chemical Formula 1, R₁ to R₄ may be a hydrogen element.

Compound 1 may include a sultone group. Compound 1 may form a stable film on a surface of a positive electrode, and may suppress or reduce decomposition of the electrolyte at a high temperature. It may thus be possible to suppress or reduce gas generation in a battery and to improve hot-temperature lifetime and high-temperature storage performance of a battery.

Compound 1 may be present in an amount of about 0.01 wt % to about 10 wt % relative to the total weight of the electrolyte. For example, Compound 1 may be present in an amount of equal to or greater than about 0.05 wt %, 0.1 wt %, 0.5 wt %, or 1 wt % relative to the total weight of the electrolyte. Compound 1 may be present in an amount of equal to or less than about 7 wt %, about 5 wt %, or about 2 wt % relative to the total weight of the electrolyte. If Compound 1 is present in the aforementioned concentration ranges, a protective film having a suitable or appropriate film resistance (e.g., electrical resistance) may be formed on an electrode surface of a lithium battery to improve cycle characteristics of a lithium battery, and gas generation in a lithium battery may be suppressed or reduced to improve high-temperature lifetime and high-temperature storage performance of a lithium battery.

The additive may include Compound 2 represented by Chemical Formula 2 below.

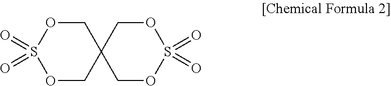 [SMILES: O=S1(=O)OCC2(CO1)COS(=O)(=O)OC2]

Compound 2 may decrease resistance (e.g., electrical resistance) of an electrode surface to improve battery output performance. Compound 2 may be present in an amount of about 0.01 wt % to about 10 wt % relative to the total weight of the electrolyte. For example, Compound 2 may be present in an amount of equal to or greater than about 0.05 wt %, 0.1 wt %, 0.5 wt %, or 1 wt % relative to the total weight of the electrolyte. Compound 2 may be present in an amount of equal to or less than about 7 wt %, about 5 wt %, or about 2 wt % relative to the total weight of the electrolyte. If Compound 2 is present in the aforementioned concentration ranges, resistance (e.g., electrical resistance) of an electrode surface of a rechargeable lithium battery may be moderately decreased to improve battery output performance.

The additive may include Compound 1 and Compound 2. Based on the combination of Compound 1 and Compound 2, the additive may improve not only high-temperature performance but also resistance (e.g., electrical resistance) increase rate of a rechargeable lithium battery, thereby improving battery output performance.

In the additive, Compound 2 may be present in an amount of about 0.1 to about 10 parts by weight relative to about 1 part by weight of the Compound 1. For example, in the additive, Compound 2 may be present in an amount of about 0.2 to about 5 parts by weight or about 0.5 to about 2 parts by weight relative to about 1 part by weight of Compound 1. If Compound 1 and Compound 2 are present in the aforementioned ratio ranges, a rechargeable lithium battery may improve in high-temperature performance and resistance (e.g., electrical resistance) increase rate, which may result in an improvement in battery output performance.

The additive may be present in an amount of about 0.1 wt % to about 10 wt % relative to the total weight of the electrolyte. For example, the additive may be present in an amount of about 0.5 wt % to about 7 wt %, about 1 wt % to about 4 wt %, about 2.1 wt % to about 4 wt %, or about 2.5 wt % to about 3.5 wt % relative to the total weight of the electrolyte. If the additive is included in excess of the above ranges, viscosity of an electrolyte including the additive may be excessively increased and reduce wettability to positive and negative electrodes. If the additive is included in a small amount less than the above ranges, the effect mentioned above may be insignificant.

### Rechargeable Lithium Battery

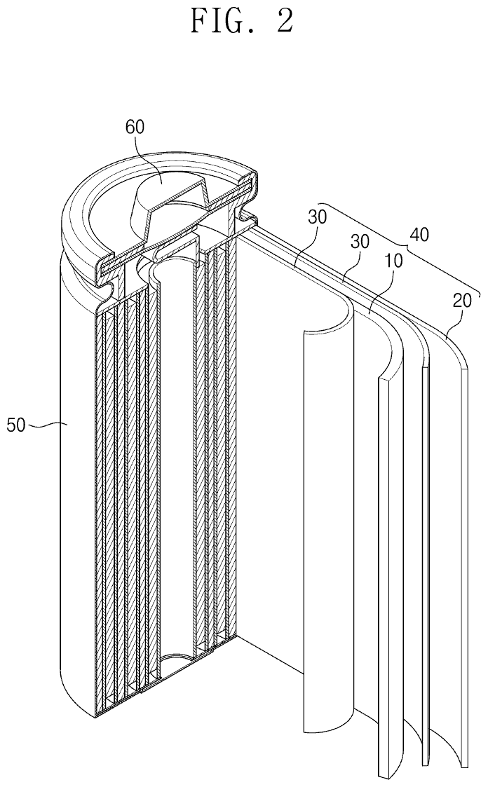

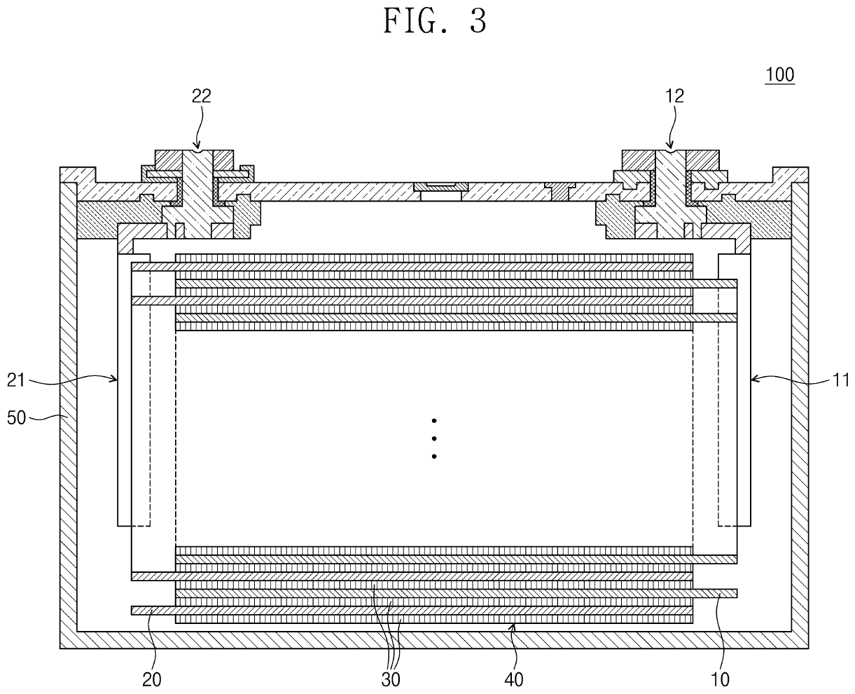

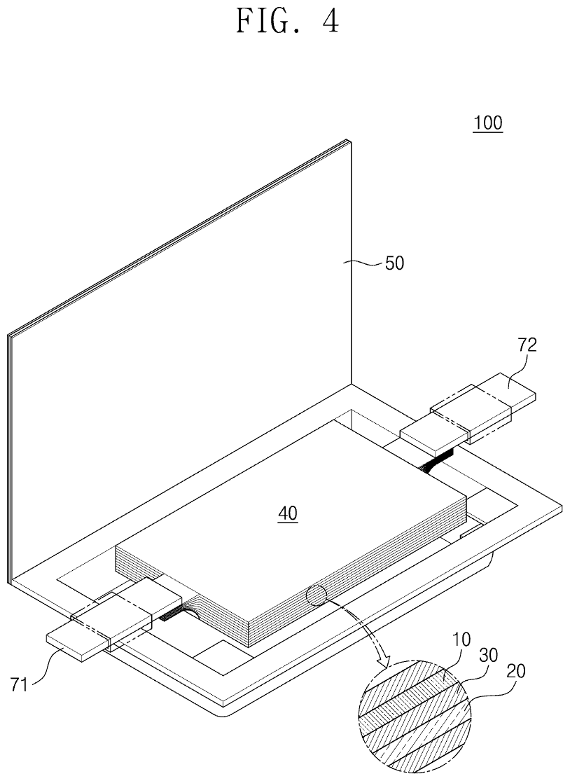

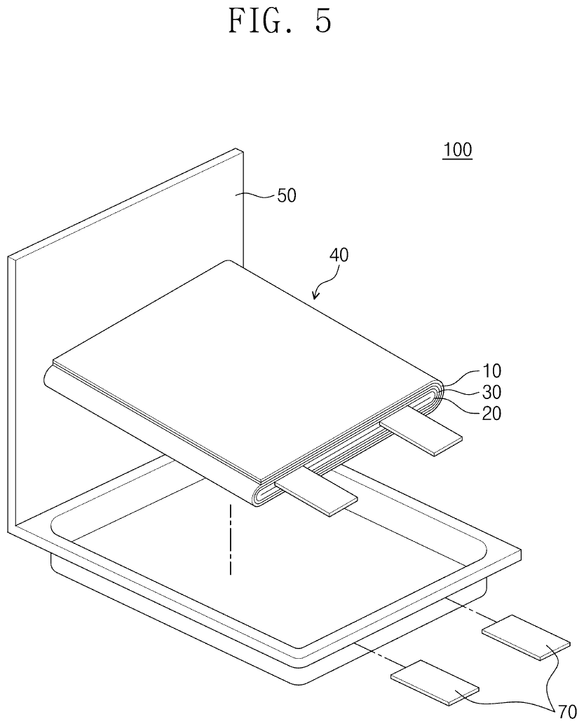

Based on shape of a rechargeable lithium battery, the rechargeable lithium battery may be classified into cylindrical, prismatic, pouch, and/or coin types (or kinds of batteries). FIGS. 2-5 are simplified diagrams showing rechargeable lithium batteries according to embodiments. FIG. 2 shows a cylindrical battery, FIG. 3 shows a prismatic battery, and FIGS. 4-5 show pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), or a positive electrode tab 71 and a negative electrode tab 72 (FIG. 4), which serves as an electrical path that externally induces a current generated in the electrode assembly 40.

A rechargeable lithium battery according to an embodiment of the present disclosure may be applied to automotive vehicles, mobile phones, and/or any other suitable electrical devices, but the present disclosure is not limited thereto.

The following will describe Examples and Comparative Examples of the present disclosure. The following example is only an embodiment of the present disclosure, and the present disclosure is not limited to the following example.

### EXAMPLES AND COMPARATIVE EXAMPLES

### Embodiment 1

### (1) Preparation of Electrolyte

LiPF₆ of about 1.0 M was dissolved in a non-aqueous organic solvent in which ethylene carbonate (EC), ethylmethyl carbonate (EMC), and dimethyl carbonate (DMC) were mixed together in a volume ratio of about 20:20:60, and an additive was added to prepare an electrolyte.

As the additive, vinylene carbonate was added in an amount of 1 wt % relative to the total amount of the electrolyte, Compound 1 represented by Chemical Formula 1-1 below was added in an amount of 0.1 wt % relative to the total amount of the electrolyte, and Compound 2 represented by Chemical Formula 2 below was added in an amount of 1 wt % relative to the total amount of the electrolyte.

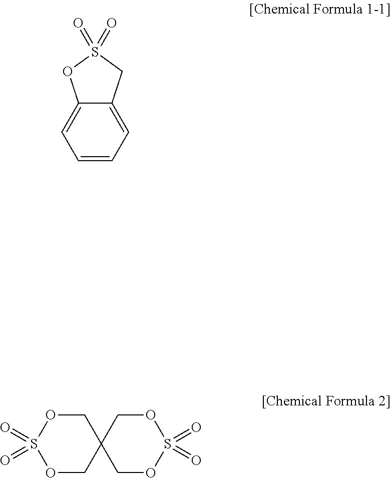 [SMILES: O=S1(=O)Cc2ccccc2O1 ; O=S1(=O)OCC2(CO1)COS(=O)(=O)OC2]

An additive in accordance with Chemical Formula 1-1 may be prepared by the following Synthesis Example below.

### Synthesis Example

2-hydroxybenzyl alcohol of 0.1 mmol and sodium bisulfite of 0.125 mmol were added dropwise to a Schlenk flask in which H₂O of 100 ml is present, and the mixture was fluxed and agitated for 24 hours. Afterwards, an excess amount of phosphoryl chloride was added to a compound obtained by filtering the resultant precipitates, and the resultant mixture was reacted neat without a solvent for 1 hour at 125° C. After that, a Soxhlet extractor was used to perform purification to obtain a compound represented by Chemical Formula 1-1.

### (2) Fabrication of Rechargeable Lithium Battery

LiNiCoAlO₂ (NCA) as a positive electrode active material, polyvinylidene fluoride as a binder, and acetylene black as a conductive material were mixed together in a weight ratio of 96:3:1, and the mixture was distributed in N-methyl pyrrolidone to prepare a positive electrode active material slurry.

The positive electrode active material slurry was coated on an Al foil of 15 μm in thickness, dried at a temperature of 100° C., and then pressed to manufacture a positive electrode.

Artificial graphite, a styrene-butadiene rubber binder, and carboxymethyl cellulose were mixed together in a weight ratio of 98:1:1, and dispersed in distilled water to manufacture a negative electrode active material slurry.

The negative electrode active material slurry was coated on a copper (Cu) foil with a thickness of 10 μm, dried at 100° C., and then pressed to manufacture a negative electrode.

The positive electrode, the negative electrode, and a 10 μm-thick polyethylene separator were assembled to manufacture an electrode assembly, and the electrolyte was introduced to fabricate a rechargeable lithium battery.

### Example 2

A rechargeable lithium battery was fabricated by the same method as that of Example 1 except that, as an additive, vinylene carbonate was added in an amount of 1 wt % relative to the total amount of the electrolyte, Compound 1 represented by Chemical Formula 1-1 was added in an amount of 0.5 wt % relative to the total amount of the electrolyte, and Compound 2 represented by Chemical Formula 2 was added in an amount of 1 wt % relative to the total amount of the electrolyte.

### Embodiment 3

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula 1-1 was added in an amount of 1 wt % relative to the total amount of the electrolyte, and Compound 2 represented by Chemical Formula 2 was added in an amount of 1 wt % relative to the total amount of the electrolyte.

### Embodiment 4

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula was added in an amount of 2 wt % relative to the total amount of the electrolyte, and Compound 2 represented by Chemical Formula was added in an amount of 1 wt % relative to the total amount of the electrolyte.

### Embodiment 5

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula 1-1 was added in an amount of 5 wt % relative to the total amount of the electrolyte, and Compound 2 represented by Chemical Formula 2 was added in an amount of 1 wt % relative to the total amount of the electrolyte.

### Embodiment 6

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula 1-1 was added in an amount of 1 wt % relative to the total amount of the electrolyte, and Compound 2 represented by Chemical Formula 2 was added in an amount of 5 wt % relative to the total amount of the electrolyte.

### Comparative Example 1

A rechargeable lithium battery was fabricated by the same method as that of Embodiment 1 except that, as an additive, vinylene carbonate was added in an amount of 1 wt % relative to the total amount of the electrolyte, and neither Compound 1 nor Compound 2 was added.

### Comparative Example 2

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula 1-1 was added in an amount of 2 wt % relative to the total amount of the electrolyte, and Compound 2 was not added.

### Comparative Example 3

A rechargeable lithium battery was fabricated by the same method as that of Embodiment 1 except that, as an additive, vinylene carbonate was added in an amount of 1 wt % relative to the total amount of the electrolyte, Compound 1 was not added, and Compound 2 represented by Chemical Formula 2 was added in an amount of 1 wt % relative to the total amount of the electrolyte.

### Comparative Example 4

A rechargeable lithium battery was fabricated by the same method as that of Embodiment 1 except that, as an additive, vinylene carbonate was added in an amount of 1 wt % relative to the total amount of the electrolyte, Compound 1 represented by Chemical Formula 1-1 was added in an amount of 10 wt % relative to the total amount of the electrolyte, and Compound 2 represented by Chemical Formula 2 was added in an amount of 1 wt % relative to the total amount of the electrolyte.

### Evaluation Example

A rechargeable lithium battery was evaluated by the following methods.

### Evaluation 1: Storage Characteristics at High Temperature (60° C.)

After the rechargeable lithium batteries according to the Examples and Comparative Examples were allowed to measure their initial direct-current internal resistance (DCIR) as ΔV/ΔI (voltage change/current change), a maximum energy state inside the battery was changed into a full charge state (SOC 100%), the battery was stored in this state for 30 days at a high temperature (60° C.), and then a direct-current internal resistance was measured to calculate a DCIR increase rate (%) according to Equation 1 below and Table 1 lists the results as follows.

DCIR increase rate (%)=(DCIR after 30 days/initial DCIR)×100 Equation 1

TABLE 1

| | | | DCIR increase rate |
|---|---|---|---|
| | | DCIR after high- | after high- |
| | | temperature | temperature |
| | Initial DCIR | storage | storage |
| Category | (mΩ) | (mΩ) | (%) |
| Example 1 | 33 | 40 | 121 |
| Example 2 | 34 | 40 | 118 |
| Example 3 | 35 | 40 | 116 |
| Example 4 | 37 | 42 | 114 |
| Example 5 | 43 | 47 | 109 |
| Example 6 | 37 | 44 | 119 |
| Comparative | 30 | 45 | 150 |
| Example 1 | | | |
| Comparative | 41 | 48 | 117 |
| Example 2 | | | |
| Comparative | 32 | 41 | 128 |
| Example 3 | | | |
| Comparative | 52 | 55 | 106 |
| Example 4 | | | |

### Evaluation 2: Storage Characteristics at High Temperature (45° C.)

After the rechargeable lithium batteries according to the Examples and Comparative Examples were allowed to measure initial direct-current internal resistance (DCIR) as ΔV/ΔI (change in voltage/change in current), a maximum energy state inside the battery was changed into a full charge state (SOC 100%), the battery was stored in this state for 30 days at a high temperature (45° C.), and then a direct-current internal resistance was measured to calculate a DCIR increase rate (%) according to Equation 1 below and Table 2 lists the results as follows.

$$DCIR increase rate ( \% ) = ( DCIR after 30 days / initial DCIR ) \times 100 \qquad Equation 1$$

TABLE 2

| | | | DCIR increase rate |
|---|---|---|---|
| | | DCIR after high- | after high- |
| | | temperature | temperature |
| | Initial DCIR | storage | storage |
| Category | (mΩ) | (mΩ) | (%) |
| Example 1 | 33 | 40 | 121 |
| Example 2 | 34 | 40 | 118 |
| Example 3 | 35 | 40 | 114 |
| Example 4 | 37 | 42 | 114 |
| Example 5 | 43 | 48 | 112 |
| Example 6 | 37 | 45 | 122 |
| Comparative | 30 | 44 | 147 |
| Example 1 | | | |
| Comparative | 41 | 47 | 115 |
| Example 2 | | | |
| Comparative | 32 | 40 | 125 |
| Example 3 | | | |
| Comparative | 52 | 57 | 110 |
| Example 4 | | | |

### Evaluation 3: Charge/Discharge Characteristics at High Temperature

The rechargeable lithium batteries according to the Examples and Comparative Examples were allowed to evaluate charge/discharge characteristics at 45° C. The rechargeable lithium battery according to Embodiments and Comparative Examples was charged and discharged at 45° C. for 120 cycles under the condition of 0.5 C charge (CC/CV, 4.3 V, 0.05C cut-off) and 0.5 C discharge (CC, 2.8 V cut-off).

A capacity retention rate was calculated according to Equation 2 below. The results are listed in Table 3.

$$Capacity retention rate ( \% ) = ( discharge capacity after 120 cycles / discharge capacity after 1 cycle ) \times 100 \qquad Equation 2$$

TABLE 3

| | Capacity retention |
|---|---|
| Category | rate at 45° C. (%) |
| Example 1 | 95.1 |
| Example 2 | 95.5 |
| Example 3 | 95.7 |
| Example 4 | 95.3 |
| Example 5 | 93.8 |
| Example 6 | 94.8 |
| Comparative | 75.2 |
| Example 1 | |
| Comparative | 93.7 |
| Example 2 | |
| Comparative | 94.5 |
| Example 3 | |
| Comparative | 93.1 |
| Example 4 | |

### Evaluation 4: Gas Generation Characteristic at High Temperature (60° C.)

The rechargeable lithium batteries according to Embodiments and Comparative Examples underwent evaluation of high-temperature gas generation characteristics. The battery was allowed to change its inner maximum energy state into a full charge state (SOC 100%) and stored in the changed state for 30 days at a high temperature (60° C.), and then a gas generation amount was evaluated and the results are listed in Table 4.

A change in volume before and after high-temperature storage was measured and the Archimedes' method was utilized to calculate the change in volume into a change in mass.

TABLE 4

| | Change in amount of gas |
|---|---|
| Category | generation at 60° C. (%) |
| Example 1 | 25 |
| Example 2 | 23 |
| Example 3 | 22 |
| Example 4 | 21 |
| Example 5 | 18 |
| Example 6 | 22 |
| Comparative | 62 |
| Example 1 | |
| Comparative | 22 |
| Example 2 | |
| Comparative | 35 |
| Example 3 | |
| Comparative | 15 |
| Example 4 | |

### Comprehensive Evaluation

Referring to Tables 1 and 2, in Comparative Example 1 that uses an additive including neither Compound 1 nor Compound 2, there was an abrupt increase in DCIR after storage at a high temperature (60° C. or 45° C.). In addition, in Comparative Example 3 that uses an additive including no Compound 1, there was also an abrupt increase in DCIR after storage at a high temperature (60° C. or 45° C.). In contrast, in Examples 1 to 6, Comparative Example 2, and Comparative Example 4, there was no abrupt increase in DCIR even after storage at a high temperature (60° C. or 45° C.). This may show that an additive including Compound 1 improves high-temperature characteristics.

Referring to Table 3, in Comparative Example 1 that uses an additive including neither Compound 1 nor Compound 2, the capacity retention rate depending on the charge/discharge cycle at a high temperature (60° C. or 45° C.) was reduced and decreased a charge/discharge cycle life.

In contrast, in Examples 1 to 6 and Comparative Examples 2 to 4 each of which uses an additive including one or both of Compound 1 and Compound 2, it was ascertained that the capacity retention rate depending on the charge/discharge cycle at a high temperature (60° C. or 45° C.) was maintained at or above a suitable or appropriate level. In particular, it was ascertained that the capacity retention rate depending on the charge/discharge cycle at a high temperature (60° C. or 45° C.) was maintained at or above a suitable or appropriate level even in the use of a relatively small amount of additive in Examples 1 to 4 each of which uses an additive including both Compound 1 and Compound 2, compared to the other Examples and Comparative Examples.

Referring to Table 4, in Comparative Example 1 that uses an additive including neither Compound 1 nor Compound 2, it was evaluated that there was a large amount of gas generation when stored at high temperature (60° C.). In the Comparative Examples that use an additive including no Compound 1, it was evaluated that there was a relatively small amount of gas generation, compared to the other Examples and Comparative Examples. In contrast, in Examples 1 to 6, Comparative Example 2, and Comparative Example 4 each of which uses an additive including Compound 1, it was ascertained that there was an effective suppression of gas generation when stored at a high temperature (60° C.). In particular, it was ascertained that the gas generation was effectively suppressed when stored at a high temperature (60° C.) even in the use of a relatively small amount of additive in the cases of Examples 1 to 4 each of which uses an additive including Compound 1 and Compound 2, compared to the other Examples and Comparative Examples.

An electrolyte according to an embodiment for a rechargeable lithium battery may achieve stabilization of an electrode and suppression or reduction of resistance (e.g., electrical resistance) increase, and thus there may be an effect of improvement in stability and lifetime characteristics at high temperatures.

While the subject matter of this disclosure has been described in connection with what is presently considered to be practical example embodiments, it is to be understood that the present disclosure is not limited to the disclosed embodiments and is intended to cover various modifications and equivalent arrangements included within the spirit and scope of the appended claims, and equivalents thereof, and therefore, the aforementioned embodiments should be understood to be examples and not limiting this disclosure in any way.

What is claimed is:

1. An electrolyte for a rechargeable lithium battery, the electrolyte comprising:
a non-aqueous organic solvent;
a lithium salt; and
an additive,
wherein the additive comprises Compound 1 represented by Chemical Formula 1 and Compound 2 represented by Chemical Formula 2, 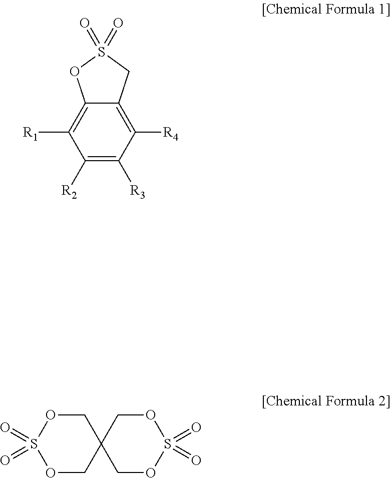
wherein, in Chemical Formula 1, R₁ to R₄ are independently one selected from a hydrogen element, a halogen element, and a substituted or unsubstituted C1 to C5 alkyl group.

2. The electrolyte as claimed in claim 1, wherein the additive is present in an amount of about 0.1 wt % to about 10 wt % relative to a total weight of the electrolyte.

3. The electrolyte as claimed in claim 1, wherein:
the Compound 1 is present in an amount of about 0.01 wt % to about 10 wt % relative to a total weight of the electrolyte, and
the Compound 2 is present in an amount of about 0.01 wt % to about 10 wt % relative to the total weight of the electrolyte.

4. The electrolyte as claimed in claim 1, wherein the R₁ to R₄ are hydrogen elements.

5. The electrolyte as claimed in claim 4, wherein the Compound 1 is present in an amount of about 0.5 wt % to about 2 wt % relative to a total weight of the electrolyte.

6. The electrolyte as claimed in claim 1, wherein the non-aqueous organic solvent comprises at least one selected from ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

7. The electrolyte as claimed in claim 6, wherein the non-aqueous organic solvent comprises ethylene carbonate (EC), ethylmethyl carbonate (EMC), and dimethyl carbonate (DMC).

8. The electrolyte as claimed in claim 1, wherein the lithium salt comprises at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

9. The electrolyte as claimed in claim 1, wherein a concentration of the lithium salt is in a range of about 0.1 M to about 2.0 M.

10. A rechargeable lithium battery, comprising:
a positive electrode that comprises a positive electrode active material;
a negative electrode that comprises a negative electrode active material; and
the electrolyte as claimed in claim 1.

11. The rechargeable lithium battery as claimed in claim 10, wherein the positive electrode active material comprises lithium metal oxide represented by Chemical Formula 3,
LiₐNi_{1-b-c}Co_{b}X_{c}O_{2-α}D_{α} [Chemical Formula 3]
wherein in Chemical Formula 3,
X is Al, Ni, Co, Mn, Cr, Fe, Mg, Sr, V, a rare-earth element, or a combination thereof,
D is O, F, S, P, or a combination thereof,
0.90≤a≤1.8,
0≤b≤0.5,
0≤c≤0.5, and
0<α<2.

12. The rechargeable lithium battery as claimed in claim 10, wherein the negative electrode active material comprises a carbon-based negative electrode active material, a silicon (Si)-based negative electrode active material, a tin (Sn)-based negative electrode active material, or a combination thereof.
